(19) United States
(12) Patent Application Publication
(10) Pub. No.: US 2009/0015726 A1
(43) Pub. Date: Jan. 15, 2009

(54) RECEIVER AND RECEIVING SYSTEM PROVIDED THEREWITH

(76) Inventor: Tsutomu JITSUHARA, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/165,872

(22) Filed: Jul. 1, 2008

(30) Foreign Application Priority Data
Jul. 11, 2007 (JP) 2007-181837

(51) Int. Cl. H04N 5/44

(52) U.S. Cl. 348/734; 348/E05.096

(57) ABSTRACT

In a receiving system including an analog TV 1 (first receiver unit), an STB (second receiver unit) externally connected to the analogy TV 1, and a STB remote control transmitter unit 5, the STB includes: an STB light receiving part 3; a control part 2H controlling operation of the STB in accordance with an infrared signal transmitted from the STB remote control transmitter unit 5 and received by the STB light receiving part 3 and selecting a remote control code for the analog TV 1 in accordance with the infrared signal transmitted from the STB remote control transmitter unit 5 and received by the STB light receiving part 3; and an STB light emitting part 4 transmitting to the analog TV 1 an infrared signal corresponding to the remote control code for the analog TV 1 selected by the control part 2H.

This application is based on Japanese Patent Application No. 2007-181837 filed on Jul. 11, 2007, the contents of which are hereby incorporated by reference.

### BACKGROUND OF THE INVENTION

1. Field of the Invention

The present invention relates to a second receiver unit which is capable of receiving a broadcast signal of a second broadcast method and which is externally connected to a first receiver unit capable of receiving a broadcast signal of a first broadcast method to thereby form a receiving system together with the first receiver unit. The invention also relates to a receiving system including a first receiver unit capable of a broadcast signal of a first broadcast method and a second receiver unit capable of receiving a broadcast signal of a second broadcast method and externally connected to the first receiver unit.

2. Description of Related Arts

Due to increasing trends toward switching from analog broadcast to digital broadcast in terrestrial broadcasting, not only a broadcast station side but also a television receiver is required to support the digital broadcast. In a period of transition from the analog broadcast to the digital broadcast, there are definitely some users who also try to view the digital broadcast with a TV receiver with which they can view the analog broadcast.

For example, with a TV receiver of an analog broadcast receiving type which has a built-in digital tuner, by applying a digital broadcast receiving device disclosed in JP-A-2004-147066, it is possible to view both analog broadcast and digital broadcast with a broadcast switching button on a remote control transmitter unit. With such a TV receiver, by applying a broadcast receiver program selection system disclosed in JP-A-2005-217587, it is possible to view both analog broadcast and digital broadcast without providing a switching button on a remote control transmitter unit.

Moreover, for example, with a TV receiver of an analog broadcast receiving type which does not have a built-in digital tuner, by externally connecting a digital tuner and applying a digital tuner control device disclosed in JP-A-2005-295263, the digital tuner can be controlled by both a remote control transmitter unit for analog broadcast and a remote control transmitter unit for digital broadcast, and broadcast to be received is switched through predetermined key operation on the remote control transmitter unit, which makes it possible to view both the analog broadcast and digital broadcast.

TV receivers of the analog broadcast receiving type which does not have a built-in digital tuner have been used so far. Thus, for users who desire to view both analog broadcast and digital broadcast by externally connecting a digital tuner, it is preferable that, a TV receiver of the analog broadcast receiving type which does not have a digital tuner and the digital tuner be both controllable by a single remote control transmitter unit and with the same operability as that of a TV receiver of the analog broadcast receiving type which has a built-in digital tuner.

Both the digital broadcast receiving device disclosed in JP-A-2004-147066 and the broadcast receiver program selection system disclosed in JP-A-2005-217587 can be operated by a single remote control transmitter unit. However, they target on a TV receiver of the analog broadcast receiving type which has a built-in digital tuner, and thus cannot control a digital tuner externally connected to a TV receiver of the analog broadcast receiving type which does not have a built-in digital tuner.

When the digital tuner control device disclosed in JP-A-2005-295263 is externally connected to the TV receiver of the analog broadcast receiving type which does not have a built-in digital tuner, the TV receiver of the analog broadcast receiving type which does not have a built-in digital tuner and the digital tuner control device are both controllable by a single remote control transmitter unit. However, to remotely control the TV receiver of the analog broadcast receiving type which does not have a built-in digital tuner, the remote control transmitter unit needs to be directed toward the TV receiver of the analog broadcast receiving type which does not have a built-in digital tuner. To remotely control the digital tuner control device, the remote control transmitter unit needs to be directed toward the digital tuner control device. Considering the directivity and reflectivity of a signal transmitted from the remote control transmitter unit, it is difficult to avoid a signal transmitted toward the digital tuner control device from being erroneously transmitted to the TV receiver of the analog broadcast receiving type which does not have a built-in digital tuner.

SUMMARY OF THE INVENTION

It is an object of the present invention to provide a second receiver unit which is capable of receiving a broadcast signal of a second broadcast method, which is externally connected to a first receiver unit capable of receiving a broadcast signal of a first broadcast method to thereby form a receiving system together with the first receiver unit, and which permits the receiving system to obtain by a remote control transmitter unit for the second receiver unit the same operability as that of a receiver having a built-in tuner for the first broad cast method and a built-in tuner for the second broadcast method.

It is another object of the invention to provide a receiving system which includes: a first receiver unit capable of receiving a broadcast signal of a first broadcast method; and a second receiver unit capable of receiving a broadcast signal of a second broadcast method and externally connected to the first receiver unit, and which obtains by a remote control transmitter unit for the second receiver unit the same operability as that of a receiver having a built-in tuner for the first broad cast method and a built-in tuner for the second broadcast method.

To achieve the objects described above, according to one aspect of the invention, a receiver for use in a receiving system including: a first receiver unit capable of receiving a broadcast signal of a first broadcast method; and a second receiver unit capable of receiving a broadcast signal of a second broadcast method and externally connected to the first receiver unit serves as the second receiver unit and includes: a light receiving part receiving an infrared signal transmitted from a remote control transmitter unit for the second receiver unit; a control part controlling operation of the second receiver unit in accordance with the infrared signal transmitted from the remote control transmitter unit for the second receiver unit and received by the light receiving part and selecting a remote control code for the first receiver unit in accordance with the infrared signal transmitted from the remote control transmitter unit for the second receiver unit and received by the light receiver part; and a light emitting part transmitting to an infrared signal receiving part of the first receiver unit an infrared signal corresponding to the remote control code for the first receiver unit selected by the control part.

Externally connecting the receiver with the configuration described above to the first receiver unit permits the first receiver unit and the second receiver unit to be remotely controlled through key operation on the remote control transmitter unit for the second receiver unit. This therefore permits providing, by the remote control transmitter unit for the second receiver unit, the same operability as that of a receiver having a built-in tuner for the first broadcast method and a built-in tuner for the second broadcast method.

The receiver with the configuration described above may further include: a storage part storing a plurality of types of remote control code groups for the first receiver unit; and a selection part selecting one remote control code group for the first receiver unit from among the plurality of types of remote control code groups for the first receiver unit stored in the storage part. Based on the remote control code group for the first receiver unit selected by the selection part, the control part may select the remote control code for the first receiver unit.

This makes it possible to support various types of the first receiver unit.

In the receiver with the configuration described above, the first broadcast method may be an analog broadcast method, and the second broadcast method may be a digital broadcast method.

To achieve the objects described above, according to another aspect of the invention, a receiving system includes: a first receiver unit capable of receiving a broadcast signal of a first broadcast method; a second receiver unit externally connected to the first receiver unit and capable of receiving a broadcast signal of a second broadcast method; and a remote control transmitter unit for the second receiver unit. The second receiver unit serves as the receiver with the configuration described above.

With such configuration, through key operation on the remote control transmitter unit for the second receiver unit, the first receiver unit and the second receiver unit can be remotely operated, thus permitting providing by the remote control transmitter unit for the second receiver unit the same operability as that of a receiver having a built-in tuner for the first broadcast method and a built-in tuner for the second broadcast method.

In the receiving system with the configuration described above, the remote control transmitter unit for the second receiver unit may have a key for selecting either one of broadcast viewing of the first broadcast method and broadcast viewing of the second broadcast method. Further, when the broadcast viewing of the second broadcast method is selected by operating the key on the remote control transmitter unit for the second receiver unit, the remote control code for the first receiver unit selected by the control part may be provided as a remote control code giving instructions for external input.

In the receiving system with the configuration described above, the remote control transmitter unit for the second receiver unit may include a channel key, and when the channel key is pressed, in a case where the broadcast viewing of the second broadcast method is selected, channel switching operation of the second receiver unit may be performed, and in a case where the broadcast viewing of the first broadcast method is selected, the remote control code for the first receiver unit selected by the control part may be provided as a remote control code giving instructions for channel switching, and the second receiver unit may turn into a standby state.

In the receiving system with the configuration described above, the remote control transmitter unit for the second receiver unit may include a power key, and when the power key is pressed, the remote control code for the first receiver unit selected by the control part may be provided as a remote control code giving instructions for power On/Off switching.

In the receiving system with the configuration described above, the remote control transmitter unit for the second receiver unit may include an external input key, and when the external input key is pressed, the remote control code for the first receiver unit selected by the control part may be provided as a remote control code giving instructions for turning into an external input state, and the second receiver unit may turn into a standby state.

In the receiving system with the configuration described above, the remote control transmitter unit for the second receiver unit may include a menu selection key, and when the menu selection key is pressed, the remote control code for the first receiver unit selected by the control part may be provided as a remote control code giving instructions for turning into an external input state.

In the receiving system with the configuration described above, the remote control transmitter unit for the second receiver unit may include a volume key, and when the volume key is pressed, the remote control code for the first receiver unit selected by the control part may be provided as a remote control code giving instructions for volume adjustment.

In the receiving system with the configuration described above, the light receiving part and the light emitting part of the second receiver unit may be each a body separate from a main body portion of the second receiver unit, and the light receiving part and the light emitting part of the second receiver unit may be arranged in front of the infrared signal receiving part provided in the first receiver unit.

This permits avoiding infrared signals, excluding those transmitted from the light emitting part, from being received by the infrared signal receiving part of the first receiver unit. Further, operating the remote control transmitter unit for the second receiver unit while directing it toward the first receiver unit permits remote control of the first receiver unit and the second receiver unit.

### BRIEF DESCRIPTION OF THE DRAWINGS

FIG. 1 is a block diagram showing one configuration example of a receiving system according to the present invention;

FIG. 2 is a diagram showing an analog TV remote control code table data;

FIG. 3 is a diagram showing main keys of a remote control key part of an STB remote control transmitter unit;

FIG. 4 is a diagram showing various operation performed by the receiving system shown in FIG. 1;

FIG. 5 is a block diagram showing one configuration example of a receiving system according to the invention when a plurality of devices are externally connected to an analog TV 1; and

FIG. 6 is a diagram showing various operations performed by the receiving system shown in FIG. 5.

### DETAILED DESCRIPTION OF PREFERRED EMBODIMENTS

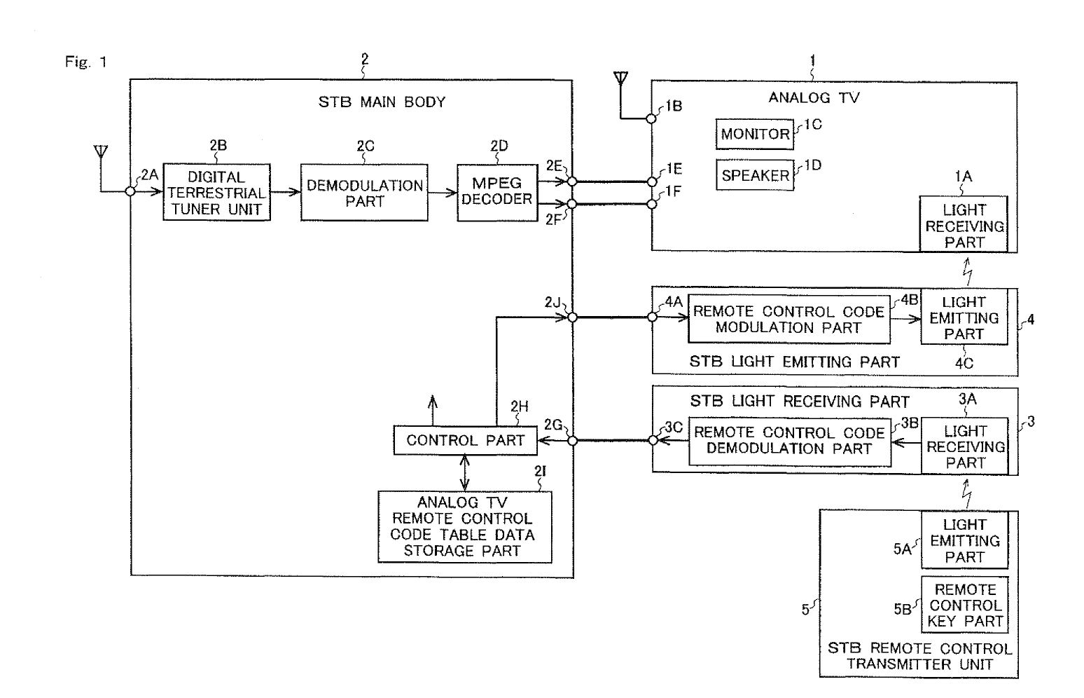

The embodiment of the present invention will be described, with reference to the accompanying drawings. FIG. 1 is a block diagram showing one configuration example of a receiving system according to the invention. The receiving system according to the invention shown in FIG. 1 is composed of: an analog TV 1 (a TV receiver unit of an analog broadcast receiving type which does not have a built-in digital tuner); a set top box (STB) according to the invention externally connected to the analog TV 1; and an STB remote control transmitter unit 5 attached to the set top box according to the invention. The set top box according to the invention is composed of: an STB main body 2, an STB light receiving part 3; and an STB light emitting part 4.

The analog TV 1 includes: a light receiving part 1A receiving an infrared signal; an antenna input terminal 1B connected with an antenna for analog broadcast reception; a monitor 1C producing a video; a speaker 1D outputting voice; a video signal external input terminal 1E, and a voice signal external input terminal 1F. The analog TV 1 performs operation in accordance with an infrared signal received by the light receiving part 1A. The analog TV1, when in an external input state, performs video display on the monitor 1C based on a video signal inputted to the video signal external input terminal 1E and voice output from the speaker 1D based on a voice signal inputted to the voice signal external input terminal 1F, and when not in external input state, performs video display on the monitor 1C and voice output from the speaker 1D based on a signal inputted to the antenna input terminal 1B.

The STB main body 2 includes: an antenna input terminal 2 connected with an antenna for digital broadcast reception; a digital terrestrial tuner unit 2B channel-selecting a broadcast to be received from among broadcast signals received by the antenna input terminal 2A and down-converting it; a demodulation part 2C demodulating a signal outputted from the digital terrestrial tuner unit 2B; an MPEG decoder 2D decoding a signal outputted from the demodulation part 2C into a video signal and a voice signal; a video signal output terminal 2E for externally outputting a video signal outputted from the MPEG decoder 2D; and a voice signal output terminal 2F for externally outputting a voice signal outputted from the MPEG decoder 2D. The video signal external input terminal 1E of the analog TV 1 and the video signal output terminal 2E of the STB main body 2 are connected to each other via a cable or the like, and the voice signal external input terminal 1F of the analog TV 1 and the voice signal output terminal 2F of the STB main body 2 are connected to each other via a cable or the like. That is, the STB main body 2 is externally connected to the analog TV 1.

Moreover, the STB main body 2 includes a terminal 2G for receiving remote control code data outputted from the STB light receiving part 3; a control part 2H which controls, based on the remote control code data received by the terminal 2G, the digital terrestrial tuner unit 2B and the other various portions of the STB main body 2, and also which outputs analog TV 1 remote control code data for remote control of the analog TV 1; an analog TV remote control code table data storage part 2I; and a terminal 2J for transmitting to the STB light emitting part 4 the analog TV 1 remote control code data outputted from the control part 2H.

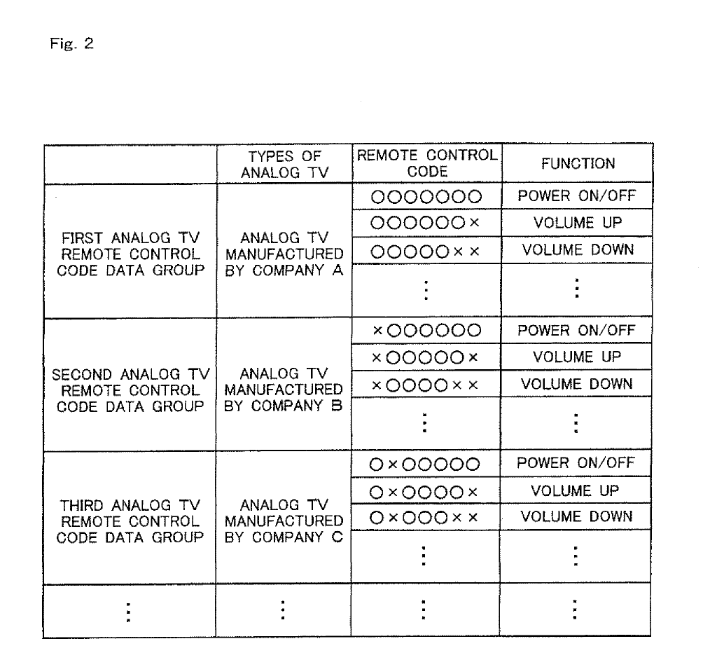

The analog TV remote control code table data storage part 2I stores in a table form data on remote control code groups for main analog TVs sold in the past (see FIG. 2). The control part 2H, in accordance with user operation, selects and uses one analog TV remote control code group from among a plurality of types of analog TV remote control code groups stored in the analog TV remote control code table data storage part 2I. For example, when the user performs key operation on the remote control transmitter attached to the analog TV 1 while directing it toward the STB light receiving part 3, the control part 2H compares the received remote control data with the plurality of types of analog TV remote control code groups stored in the analog TV remote control code table data storage part 2I, and based on a result of this comparison, selects and uses one analog TV remote control code group from among the plurality of types of analog TV remote control code groups stored in the analog TV remote control code table data storage part 2I.

In addition, the control part 2H stores an STB remote control code group, and with reference to the STB remote control code group, controls the various parts of the STB main body 2 so as to execute operation in accordance with the received remote control code data.

The STB light receiving part 3 includes: a light receiving part 3A converting a received infrared signal into an electrical signal; a remote control code demodulation part 3B demodulating the electrical signal outputted from the light receiving part 3A into remote control code data; and a terminal 3C for transmitting the remote control code data outputted from the remote control code demodulation part 3B to the STB main body 2. The STB light emitting part 4 includes: a terminal 4A for receiving the analog TV 1 remote control code data transmitted from the STB main body 2; a remote control code modulation part 4B modulating the analog TV 1 remote control code data received by the terminal 4A; and a light emitting part 4C converting a modulated signal outputted from the remote control code modulation part 4B into an infrared signal and outputting it. The terminal 2G of the STB main body 2 and the terminal 3C of the STB light receiving part 3 are connected to each other via a cable or the like, and the terminal 2J of the STB main body 2 and the terminal 4A of the STB light emitting part 4 are connected to each other via a cable or the like.

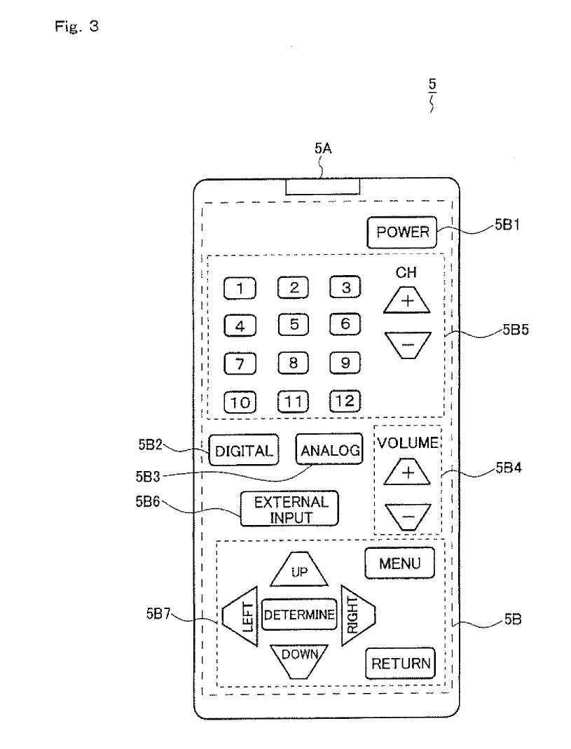

The STB remote control transmitter unit 5 attached to the set top box according to the invention includes: a light emitting part 5A and a remote control key part 5B. When any key of the remote control key part 5B is pressed by the user, remote control code data assigned to a function of this pressed key is modulated, then converted into an infrared signal, and then transmitted from the light emitting part 5A. FIG. 3 shows main keys of the remote control key part 5B of the STB remote control transmitter unit 5. A description will be given below, concerning operation performed when these main keys are pressed by the user.

When a power key 5B1 is pressed by the user under the condition that the light emitting part 5A of the STB remote control transmitter unit 5 is directed toward the STB light receiving part 3, remote control code data assigned to the power key 5B1 is received by the control part 2H. The control part 2H, which has received the remote control code data assigned to the power key 5B1, controls the various parts of the STB main body 2 so as to switch between the power ON and OFF of the STB main body 2. The control part 2H also, with reference the data stored in the analog TV remote control code table data storage part 2I, outputs to the terminal 2J remote control code corresponding to a power ON/OFF switching function for the analog TV 1. Consequently, the power ON and OFF of both the analog TV 1 and the STB main body 2 are switched.

When a digital key 5B2 is pressed by the user under the condition that the light emitting part 5A of the STB remote control transmitter unit 5 is directed toward the STB light receiving part 3, remote control code data assigned to the digital key 5B2 is received by the control part 2H. The control part 2H, which has received the remote control code data assigned to the digital key 5B2, turns into a digital broadcast viewing mode, and controls the various parts of the STB main body 2 so as to put the STB main body 2 into a normal operation state. The control part 2H also, with reference to the data stored in the analog TV remote control code table data storage part 2I, outputs to the terminal 2J remote control code corresponding to an external input function for the analog TV 1. Consequently, the analog TV 1 turns into an external input state, and the STB main body 2 turns into a normal operation state, thereby permitting digital broadcast viewing.

When a analog key 5B3 is pressed by the user under the condition that the light emitting part 5A of the STB remote control transmitter unit 5 is directed toward the STB light receiving part 3, remote control code data assigned to the analog key 5B3 is received by the control part 2H. The control part 2H, which has received the remote control code data assigned to the analog key 5B3, turns into an analog broadcast viewing mode, and controls the various parts of the STB main body 2 so as to put the STB main body 2 into a standby state. The control part 2H also, with reference to the data stored in the analog TV remote control code table data storage part 2I, outputs to the terminal 2J remote control code corresponding to a non-external-input function for the analog TV 1. Consequently, the analog TV 1 turns into a non-external-input state, and the STB main body 2 turns into a standby state, thereby permitting analog broadcast viewing.

When either of volume keys 5B4 (volume up key and volume down key) is pressed by the user under the condition that the light emitting part 5A of the STB remote control transmitter unit 5 is directed toward the STB light receiving part 3, remote control code data assigned to the pressed key of the volume keys 5B4 is received by the control part 2H. The control part 2H, which has received the remote control code data assigned to the pressed key of the volume keys 5B4, with reference the data stored in the analog TV remote control code table data storage part 2I, outputs to the terminal 2J remote control code corresponding to a volume adjustment function for the analog TV 1. Consequently, the volume of voice outputted from the speaker ID of the analog TV 1 is adjusted.

When any of channel switch keys (channel up key, channel down key, and direct channel selection numerical key) 5B5 is pressed by the user under the condition that the light emitting part 5A of the STB remote control transmitter unit 5 is directed toward the STB light receiving part 3, remote control code data assigned to the pressed key of the channel switch keys 5B5 is received by the control part 2H.

The control part 2H, which has received the remote control code data assigned to the pressed key of the channel switch keys 5B5, when in an analog broadcast viewing mode, controls the various parts of the STB main body 2 so as to put the STB main body 2 into a standby state. The control part 2H also, with reference the data stored in the analog TV remote control code table data storage part 2I, outputs to the terminal 2J remote control code corresponding to a channel switch function for the analog TV 1. Consequently, channel selection for analog broadcast received by the analog TV 1 is performed. The analog TV 1, even in an external input state, transits to a non-external-input state when receiving remote control code for channel switching to execute the channel selection.

The control part 2H, which has received the remote control code data assigned to the pressed key of the channel switch keys 5B5, when in a digital broadcast viewing mode, with reference to the data stored in the analog TV remote control code table data storage part 2I, outputs to the terminal 2J the remote control code corresponding to the external input function for the analog TV 1, and also controls the digital terrestrial tuner unit 2B so that a channel for digital broadcast to be received by the STB main body 2 is selected. The remote control code corresponding to the external input function for the analog TV 1 is outputted to the terminal 2J by the control part 2H because the analog TV 1 can be in a non-external input state as a result of operating the keys provided in the analog TV 1 by the user.

When an external input key 5B6 is pressed by the user under the condition that the light emitting part 5A of the STB remote control transmitter unit 5 is directed toward the STB light receiving part 3, remote control code data assigned to the external input key 5B6 is received by the control part 2H. The control part 2H, which has received the remote control code data assigned to the external input key 5B6, controls the various parts of the STB main body 2 so as to put the STB main body 2 into a standby state. The control part 2H also, with reference the data stored in the analog TV remote control code table data storage part 2I, outputs to the terminal 2J the remote control code corresponding to the external input function for the analog TV 1. Consequently, the analog TV 1 turns into an external input state, and the STB main body 2 turns into a standby state.

When any of menu selection keys (up-, down-, right-, and left-keys, determine key, return key, and menu key) 5B7 is pressed by the user under the condition that the light emitting part 5A of the STB remote control transmitter unit 5 is directed toward the STB light receiving part 3, remote control code data assigned to the pressed key of the menu selection keys 5B7 is received by the control part 2H. The control part 2H, which has received the remote control code data assigned to the pressed key of the menu selection keys 5B7, controls the various parts of the STB main body 2 so that the STB main body 2 performs operation in accordance with the received remote control code data in a normal operation state. The control part 2H also, with reference the data stored in the analog TV remote control code table data storage part 2I, outputs to the terminal 2J the remote control code corresponding to the external input function for the analog TV 1. Consequently, the analog TV 1 turns into an external input state, and the STB main body 2 performs operation in accordance with the function assigned to the pressed key of the menu selection keys 5B7.

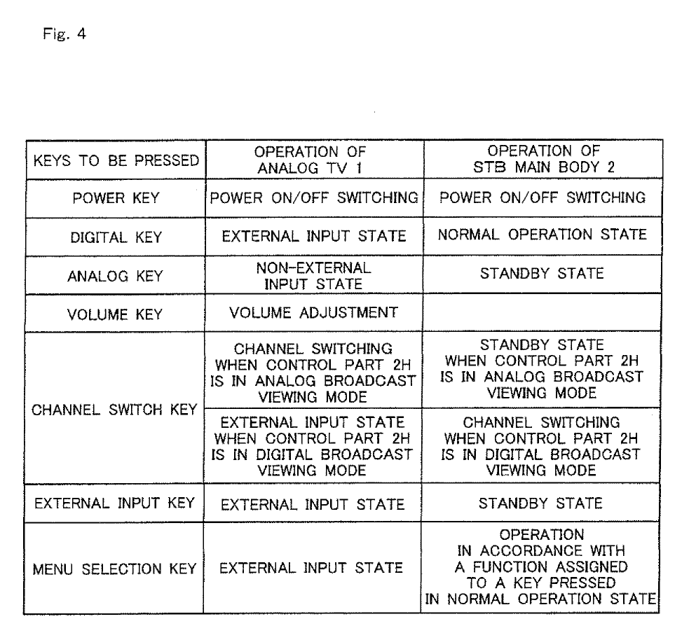

FIG. 4 summarizes the operations described above. Note that the remote control key part 5B of the STB remote control transmitter unit 5 may be provided with, in addition to the main keys illustrated in FIG. 3, keys, such as EPG-related keys and data-broadcast-related keys, which are used not for analog broadcast but for digital broadcast.

Arranging the STB light emitting part 4 in front of the light receiving part 1A of the analog TV 1 permits preventing infrared signals, excluding those transmitted from the STB light emitting part 4, from being received by the light receiving part 1A of the analog TV 1. Further, attaching together the back surfaces of the STB light receiving part 3 and the STB light emitting part 4 permits operating the analog TV 1 and the set top box according to the invention by operating the STB remote control transmitter 5 while directing it toward the analog TV 1.

Elongating a wire between the STB main body 2 and the STB light receiving part 3 and a wire between the STB main body 2 and the STB light emitting part 4 eliminates the needs of arranging the STB main body 2 near the analog TV 1.

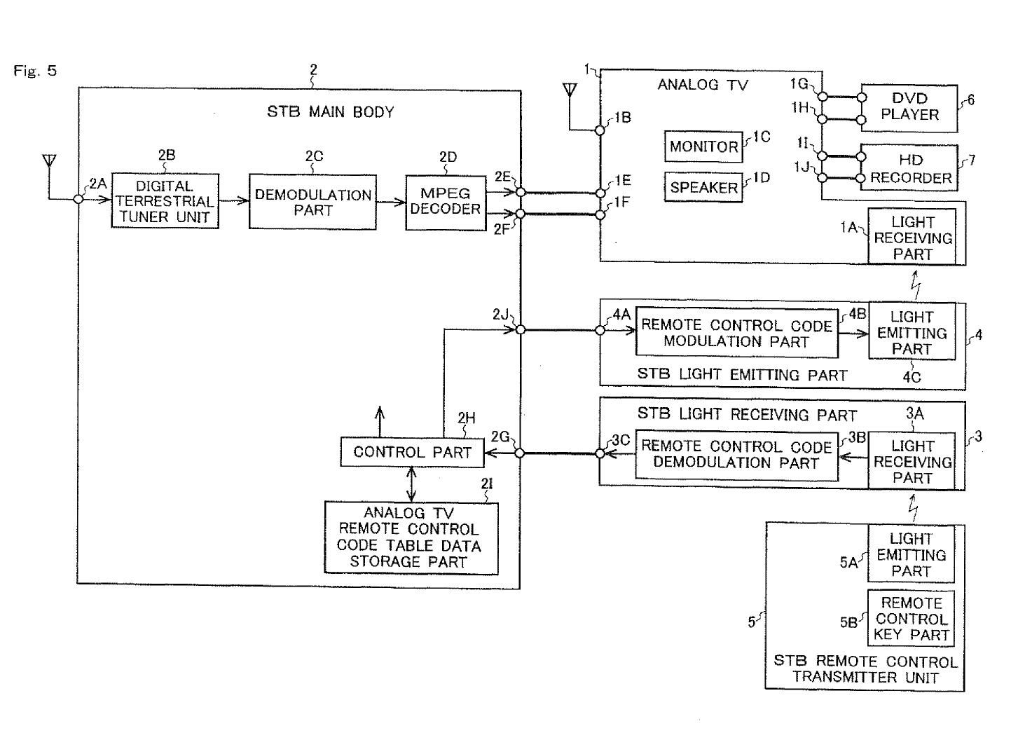

The device externally connected to the analog TV 1 is not limited to the STB according to the invention only. FIG. 5 is a diagram showing one configuration example of a receiving system according to the invention when a plurality of devices are externally connected to the analog TV 1. In FIG. 5, portions the same as those in FIG. 1 are provided with the same numerals and omitted from description.

The receiving system according to the invention shown in FIG. 5 is composed of: the analog TV 1; the STB according to the invention which includes the STB main body 2, the STB light receiving part 3, and the STB light emitting part 4 and which is externally connected to the analog TV 1; the STB remote control transmitter unit 5 attached to the set top box according to the invention; and devices, excluding the STB according to the invention, externally connected to the analog TV 1. As an example of the devices, excluding the STB according to the invention, externally connected to the analog TV 1, a DVD player 6 and a hard disc recorder (HD recorder) 7 are illustrated, and any devices, for example, a VTR, a video camera, and the like, connectable to the analog TV 1 are permitted.

Here, assume that the STB main body 2 is externally connected to a first external input (video signal external input terminal 1E and voice signal external input terminal 1F) of the analog TV 1, the DVD player 6 is externally connected to a second external input (video signal external input terminal 1G and voice signal external input terminal 1H) of the analog TV 1, and the HD recorder 7 is externally connected to a third external input (video signal external input terminal 1I and voice signal external input terminal 1J) of the analog TV 1.

Hereinafter, for operation of the receiving system according to the invention shown in FIG. 5 when the user presses the main keys of the remote control key part 5B of the STB remote control transmitter unit 5, while points the same as those of the receiving system according to the invention shown in FIG. 1 are omitted from description, only points different from those of the receiving system according to the invention shown in FIG. 1 will be described.

When the digital key 5B2 is pressed by the user under the condition that the light emitting part 5A of the STB remote control transmitter unit 5 is directed toward the STB light receiving part 3, remote control code data assigned to the digital key 5B2 is received by the control part 2H. The control part 2H, which has received the remote control code data assigned to the digital key 5B2, turns into a digital broadcast viewing mode and controls the various parts of the STB main body 2 so as to put the STB main body 2 into a normal operation state. The control part 2H also, with reference the data stored in the analog TV remote control code table data storage part 2I, outputs to the terminal 2J remote control code corresponding to a first external input function for the analog TV 1. Consequently, the analog TV 1 turns into a first external input state in which video display and voice output based on a video signal and a voice signal inputted to the first external input (video signal external input terminal 1E and voice signal external input terminal 1F) of the analog TV 1 are performed, and the STB main body 2 turns into a normal operation state, thereby permitting digital broadcast viewing.

When any of the channel switch keys (channel up key, channel down key, and direct channel selection numerical key) 5B5 is pressed by the user under the condition that the light emitting part 5A of the STB remote control transmitter unit 5 is directed toward the STB light receiving part 3, remote control code data assigned to the pressed key of the channel switch keys 5B5 is received by the control part 2H. The control part 2H, which has received the remote control code data assigned to the pressed key of the channel switch keys 5B5, when in a digital broadcast viewing mode, with reference the data stored in the analog TV remote control code table data storage part 2I, outputs to the terminal 2J the remote control code corresponding to the first external input function for the analog TV 1, and also controls the digital terrestrial tuner unit 2B so that channel selection for digital broadcast to be received by the STB main body 2 is performed. Consequently, the analog TV 1 turns into an external input state in which video display and voice output based on a video signal and a voice signal inputted to the first external input (video signal external input terminal 1E and voice signal external input terminal 1F) of the analog TV 1 are performed.

When the external input key 5B6 is pressed by the user under the condition that the light emitting part 5A of the STB remote control transmitter unit 5 is directed toward the STB light receiving part 3, remote control code data assigned to the external input key 5B6 is received by the control part 2H. The control part 2H, which has received the remote control code data assigned to the external output key 5B6, controls the various parts of the STB main body 2 so as to put the STB main body 2 into a standby state. The control part 2H also, with reference the data stored in the analog TV remote control code table data storage part 2I, outputs to the terminal 2J remote control code corresponding to a send external input function or a third external input function for the analog TV 1. Consequently, the analog TV 1 turns into a second external input state, in which video display and voice output based on a video signal and a voice signal inputted to the second external input (video signal external input terminal 1G and voice signal external input terminal 1H) of the analog TV 1 are performed, or into a third external input state, in which video display and voice output based on a video signal and a voice signal inputted to the third external input (video signal external input terminal 1I and voice signal external input terminal 1J) of the analog TV 1 are performed, and the STB main body 2 turns into a standby state.

When any of the menu selection keys (up-, down-, right-, and left-keys, determine key, return key, and menu key) 5B7 is pressed by the user under the condition that the light emitting part 5A of the STB remote control transmitter unit 5 is directed toward the STB light receiving part 3, remote control code data assigned to the pressed key of the menu selection keys 5B7 is received by the control part 2H. The control part 2H, which has received the remote control code data assigned to the pressed key of the menu selection keys 5B7, controls the various parts of the STB main body 2 so that the STB main body 2 performs operation in accordance with the received remote control code data in a normal operation state. The control part 2H also, with reference the data stored in the analog TV remote control code table data storage part 2I, outputs to the terminal 2J the remote control code corresponding to the first external input function for the analog TV 1. Consequently, the analog TV 1 turns into an first external input state in which video display and voice output based on a video signal and a voice signal inputted to the first external input (video signal external input terminal 1E and voice signal external input terminal 1F) of the analog TV 1 are performed, and the STB main body 2 performs operation in accordance with the function assigned to the pressed key of the menu selection keys 5B7.

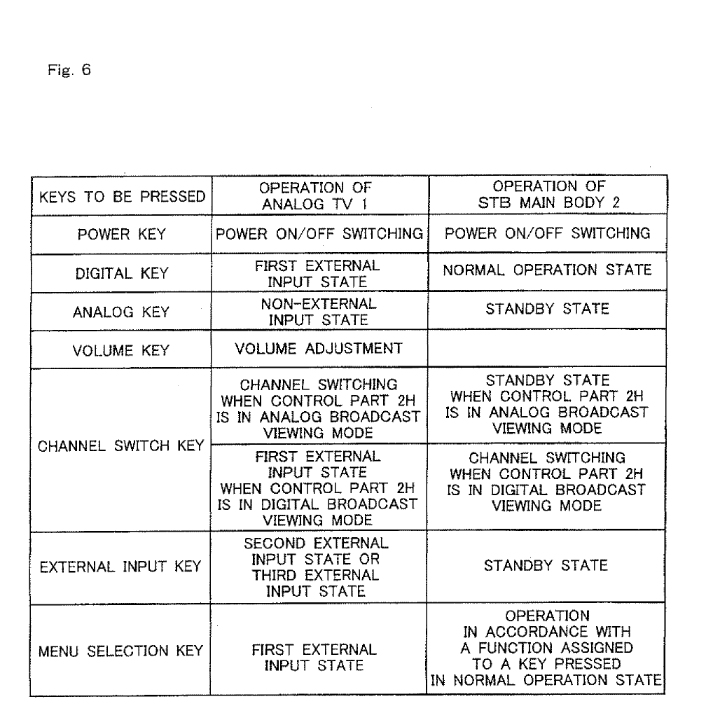

FIG. 6 is a table summarizing the operations described above.

What is claimed is:

1. A receiver for use in a receiving system including: a first receiver unit capable of receiving a broadcast signal of a first broadcast method; and a second receiver unit capable of receiving a broadcast signal of a second broadcast method and externally connected to the first receiver unit,
the receiver serving as the second-receiver unit and comprising:
a light receiving part receiving an infrared signal transmitted from a remote control transmitter unit for the second receiver unit;
a control part controlling operation of the second receiver unit in accordance with the infrared signal transmitted from the remote control transmitter unit for the second receiver unit and received by the light receiving part, the control part selecting a remote control code for the first receiver unit in accordance with the infrared signal transmitted from the remote control transmitter unit for the second receiver unit and received by the light receiver part; and
a light emitting part transmitting to an infrared signal receiving part of the first receiver unit an infrared signal corresponding to the remote control code for the first receiver unit selected by the control part.

2. The receiver according to claim 1, further comprising:
a storage part storing a plurality of types of remote control code groups for the first receiver unit; and
a selection part selecting one remote control code group for the first receiver unit from among the plurality of types of remote control code groups for the first receiver unit stored in the storage part,
wherein based on the remote control code group for the first receiver unit selected by the selection part, the control part selects the remote control code for the first receiver unit.

3. The receiver according to claim 1,
wherein the first broadcast method is an analog broadcast method and the second broadcast method is a digital broadcast method.

4. A receiving system comprising:
a first receiver unit capable of receiving a broadcast signal of a first broadcast method;
a second receiver unit externally connected to the first receiver unit and capable of receiving a broadcast signal of a second broadcast method; and
a remote control transmitter unit for the second receiver unit,
wherein the second receiver unit includes:
a light receiving part receiving an infrared signal transmitted from the remote control transmitter unit for the second receiver unit;
a control part controlling operation of the second receiver unit in accordance with the infrared signal transmitted from the remote control transmitter unit for the second receiver unit and received by the light receiving part, the control part selecting a remote control code for the first receiver unit in accordance with the infrared signal transmitted from the remote control transmitter unit for the second receiver unit and received by the light receiving part; and
a light emitting part transmitting to an infrared signal receiving part of the first receiver unit an infrared signal corresponding to the remote control code for the first receiver unit selected by the control part.

5. The receiving system according to claim 4,
wherein the second receiver unit further includes:
a storage part storing a plurality of types of remote control code groups for the first receiver unit; and
a selection part selecting one remote control group for the first receiver unit from among the plurality of types of remote control groups for the first receiver unit stored in the storage part, and
wherein based on the remote control code group for the first receiver unit selected by the selection part, the control part selects the remote control code for the first receiver unit.

6. The receiving system according to claim 4,
wherein the first broadcast method is an analog broadcast method and the second broadcast method is a digital broadcast method.

7. The receiving system according to claim 4,
wherein the remote control transmitter unit for the second receiver unit has a key for selecting either one of broadcast viewing of the first broadcast method and broadcast viewing of the second broadcast method.

8. The receiving system according to claim 7,
wherein when the broadcast viewing of the second broadcast method is selected by operating the key on the remote control transmitter unit for the second receiver unit, the remote control code for the first receiver unit selected by the control part is provided as a remote control code giving instructions for external input.

9. The receiving system according to claim 8,
wherein the remote control transmitter unit for the second receiver unit includes a channel key, and when the channel key is pressed, in a case where the broadcast viewing of the second broadcast method is selected, channel switching operation of the second receiver unit is performed, and in a case where the broadcast viewing of the first broadcast method is selected, the remote control code for the first receiver unit selected by the control part is provided as a remote control code giving instruction for channel switching, and the second receiver unit turns into a standby state.

10. The receiving system according to claim 4,
wherein the remote control transmitter unit for the second receiver unit includes a power key, and when the power key is pressed, the remote control code for the first receiver unit selected by the control part is provided as a remote control code giving instructions for power On/Off switching.

11. The receiving system according to claim 4,
wherein the remote control transmitter unit for the second receiver unit includes an external input key, and when the external input key is pressed, the remote control code for the first receiver unit selected by the control part is provided as a remote control code giving instructions for turning into an external input state, and the second receiver unit turns into a standby state.

12. The receiving system according to claim 4,
wherein the remote control transmitter unit for the second receiver unit includes a menu selection keys and when the menu selection key is pressed, the remote control code for the first receiver unit selected by the control part is provided as a remote control code giving instructions for turning into an external input state.

13. The receiving system according to claim 4,
wherein the remote control transmitter unit for the second receiver unit includes a volume key, and when the volume key is pressed, the remote control code for the first receiver unit selected by the control part is provided as a remote control code giving instructions for volume adjustment.

14. The receiving system according to claim 4,
wherein the light receiving part and the light emitting part of the second receiver unit are each a body separate from a main body portion of the second receiver unit, and the light receiving part and the light emitting part of the second receiver unit are arranged in front of the infrared signal receiving part provided in the first receiver unit.
